(19) United States
(12) Patent Application Publication
(10) Pub. No.: US 2016/0246510 A1
(43) Pub. Date: Aug. 25, 2016

(54) PLATFORM NON-VOLATILE STORAGE MANAGEMENT AND PLATFORM CONFIGURATION

(71) Applicant: INTEL CORPORATION, (US)

(72) Inventors: Michael A. ROTHMAN, Puyallup, WA (US); Vincent J. ZIMMER, Federal Way, WA (US); Daniel M. KROGH, Beaverton, OR (US)

(21) Appl. No.: 14/129,791

(22) PCT Filed: Oct. 30, 2013
(86) PCT No.: PCT/US2013/067451

§ 371 Date: Dec. 27, 2013

(51) Int. Cl. G06F 3/06; G06F 12/02

(52) U.S. Cl. CPC G06F 3/0607; G06F 3/0688; G06F 3/0655; G06F 12/0246; G06F 2212/7202

(57) ABSTRACT

Technologies for providing services to a non-volatile store include a computing device having a non-volatile store policy that defines a minimum amount of reserved space in the non-volatile store. The mobile computing device receives a call for services to the non-volatile store, determines useable free space in the non-volatile store based on the non-volatile store policy, and responds to the call for services based on the useable free space. Technologies for platform configuration include a computing device having a firmware environment and an operating system. The firmware environment determines information on configuration settings inaccessible to the operating system and exports the information to the operating system. The operating system determines a new configuration setting based on the exported information, and may configure the computing device at runtime. The operating system may securely pass a configuration directive to the firmware environment for configuration during boot. Other embodiments are described and claimed.

### BACKGROUND

Computing devices often execute a boot process according to the Unified Extensible Firmware Interface (“UEFI”) specification, which has several versions published by the Unified EFI Forum. The UEFI specification specifies an interface between the firmware of the computing device and the operating system of the computing device. The UEFI specification specifies a standard model for firmware drivers and applications that execute in a pre-operating system environment. In addition to performing traditional boot and initialization tasks, such drivers and applications may perform other tasks, such as diagnostic, maintenance, or management tasks.

Modern computer systems allow boot and runtime applications, such as operating system drivers, to store variables in the platform non-volatile (“NV”) memory store. For example, the UEFI specification defines several variable functions allowing access to NV store. However, the NV store is typically a small amount of memory that must be shared by the platform firmware as well as the firmware configuration variable. The firmware also typically needs a small amount of space in the NV store on a temporary basis while performing boot operations. When attempting to boot at times during which the NV store is completely filled, the firmware may crash, hang, fail to boot, or otherwise render the platform unusable. That condition of an unusable platform is sometimes known as being “bricked”—that is, the platform is as useful as a brick, although typically somewhat less durable.

Additionally, modern computer platforms, including processors, chipsets, and other supporting features, have numerous configuration settings and options. Typically, the device manufacturer establishes the base configuration of the platform, and the platform firmware configures the platform on boot. Some configuration settings are available to the user, for example through a pre-boot basic input/output system (“BIOS”) interface, or to an operating system; however, many configuration settings are not available to the user or the operating system. Changes to the configuration settings may require updating the platform firmware, for example by re-flashing the platform NV store. Misconfiguration can substantially decrease the performance of the platform.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for platform non-volatile store management and platform configuration;

FIG. 2 is a simplified block diagram of at least one embodiment of an environment of a computing device of the system of FIG. 1;

FIG. 3 is a simplified block diagram of at least one embodiment of another environment of the computing device of FIG. 1;

FIG. 4 is a simplified schematic diagram of at least one embodiment of a boot process according to the UEFI specification that may be executed by the computing device of FIGS. 1 and 2;

FIGS. 5A-5D are simplified flow diagrams of at least one embodiment of a method for platform non-volatile store management that may be executed by the computing device of FIGS. 1 and 2;

FIGS. 6A-6B are simplified flow diagrams of at least one embodiment of a method for platform configuration that may be executed by the computing device of FIGS. 1 and 2; and

FIG. 7 is a simplified flow diagram of at least one embodiment of a method for platform configuration that may be executed by an administrative server of the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

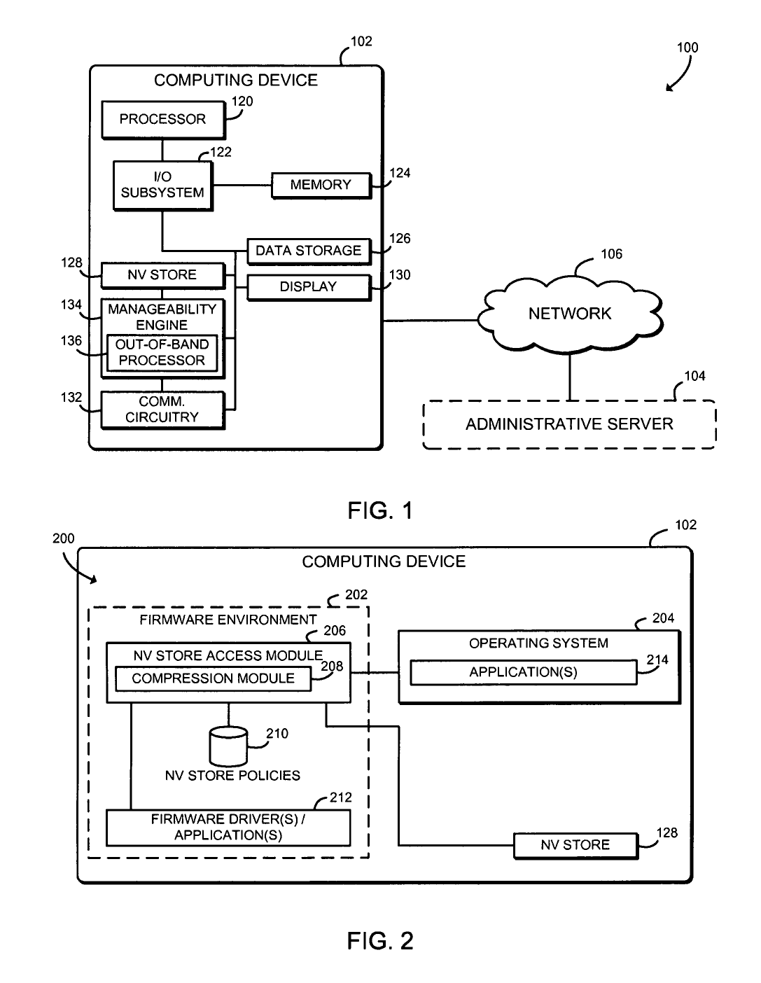

Referring now to FIG. 1, in one embodiment, a system 100 for non-volatile store management and platform configuration includes a computing device 102 capable of communication over a network 106. In some embodiments, the system 100 includes an administrative server 104 in communication with the computing device 102. In use, as described below, the computing device 102 manages access to a platform non-volatile (“NV”) memory store according to one or more platform policies. The computing device 102 also exports platform configuration settings to a runtime operating system. The runtime operating system may determine that the computing device 102 is not optimally configured, and may generate configuration directives to improve the configuration of the computing device 102. The configuration directives may be performed at runtime, or may be securely communicated to platform firmware to be executed upon reboot. In some embodiments, the configuration settings are made available to the administrative server 104, which may transmit configuration directives to the computing device 102 via an out-of-band manageability engine of the computing device 102. The disclosed technologies allow for continued use of the platform NV store by trusted and untrusted applications, while increasing system security and stability. Additionally, the disclosed technologies allow for the configuration of the computing device 102 to be optimized after deployment, without replacing or re-flashing the platform firmware.

The computing device 102 may be embodied as any type of device for performing the functions described herein. For example, the computing device 102 may be embodied as, without limitation, a smart phone, a tablet computer, a laptop computer, a notebook computer, a mobile computing device, a cellular telephone, a handset, a messaging device, a vehicle telematics device, a server computer, a workstation, a distributed computing system, a multiprocessor system, a consumer electronic device, and/or any other computing device configured to perform the functions described herein. As shown in FIG. 1, the illustrative computing device 102 includes a processor 120, an input/output subsystem 122, a memory 124, and a data storage device 126. Of course, the computing device 102 may include other or additional components, such as those commonly found in a mobile and/or stationary computers (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The data storage device 126 may include a system partition that stores data and firmware code for the computing device 102. The data storage device 126 may also include an operating system partition that stores data files and executables for an operating system of the computing device 102.

The computing device 102 further includes a non-volatile (“NV”) store 128. The NV store 128 may be embodied as any device configured for persistent storage of data when the computing device 102 is powered down or disconnected from a power supply. In the illustrative embodiment, the NV store 128 is a flash memory chip. In other embodiments, the NV store 128 may be embodied as a small amount of complementary metal-oxide semiconductor (“CMOS”) memory coupled with a battery backup or other non-volatile memory. The NV store 128 may be used to store platform firmware for the computing device 102, as well as firmware configuration variables such as configuration settings, boot targets, and other information that should persist across reboots. The NV store 128 typically has a relatively small storage capacity compared to the data storage device 126, but is available to the computing device 102 upon initial boot. In some embodiments, the NV store 128 may be incorporated into one or more other components of the computing device 102, for example into the I/O subsystem 122.

The computing device 102 further includes a display 130. The display 130 may be embodied as any type of display capable of displaying digital information such as a liquid crystal display (LCD), a light emitting diode (LED), a plasma display, a cathode ray tube (CRT), or other type of display device. In some embodiments, the display 130 may be coupled to a touch screen to allow user interaction with the computing device 102.

The computing device 102 further includes a communication circuit 132, which may be embodied as any communication circuit, device, or collection thereof, capable of enabling communications between the computing device 102, the administrative server 104 and/or other remote devices. The communication circuit 132 may be configured to use any one or more communication technology (e.g., wireless or wired communications) and associated protocols (e.g., Ethernet, Bluetooth®, Wi-Fi®, WiMAX, etc.) to effect such communication. The communication circuit 132 may be embodied as a network adapter, including a wireless network adapter.

The illustrative computing device 102 also includes a manageability engine 134. The manageability engine 134 is embodied as a device that provides remote configuration, control, or management of the computing device 102. The illustrative manageability engine 134 includes an out-of-band processor 136. The out-of-band processor 136 is separate and distinct from the main processor 120 of the computing device 102. As such, the manageability engine 134 is capable of operating independently of the state of the rest of the computing device 102. That is, the manageability engine 134 is capable of operating regardless of the operating state of the processor 120, including when the computing device 102 is powered off, when the computing device 102 is executing a pre-boot firmware environment, when an operating system of the computing device 102 is active, and when the operating system is crashed or otherwise inactive. The manageability engine 134 is also capable of communicating using the communication circuit 132 independently of the state of the computing device 102, also known as “out-of-band” communication. In some embodiments, the manageability engine 134 may include a dedicated network adaptor for such out-of-band communication, in addition to, or instead of, connecting via the communications circuit 132. The manageability engine 134 is also capable of out-of-band access of the NV store 128; that is, the manageability engine 134 is capable of accessing the NV store 128 independently of the state of the computing device 102. The manageability engine 134 may also be capable of accessing a secure storage region within the NV store 128 that is not accessible by other components of the computing device 102. In some embodiments, the manageability engine 134 may be incorporated into or otherwise form a part of the I/O subsystem 122.

In embodiments of the system 100 that include the administrative server 104, the administrative server 104 is configured to receive exported configuration settings from the computing device 102 and transmit configuration directives to the computing device 102. The administrative server 104 may communicate directly with the manageability engine 134, which may appear as a separate host on the network 106. The administrative server 104 may be embodied as any type of data server or similar computing device capable of performing the functions described herein. As such, the administrative server 104 may include components and features similar to the computing device 102, such as a processor, I/O subsystem, memory, data storage, communication circuitry, and various peripheral devices, which are not illustrated in FIG. 1 for clarity of the present description. Further, the administrative server 104 may be embodied as a single server computing device or a collection of servers and associated devices. For example, in some embodiments, the administrative server 104 is embodied as a cloud service to perform the functions described herein. In such embodiments, the administrative server 104 may be embodied as a “virtual server” formed from multiple computing devices distributed across the network 106 and operating in a public or private cloud. Accordingly, although the administrative server 104 is illustrated in FIG. 1 and described below as embodied as single server computing device, it should be appreciated that the administrative server 104 may be embodied as multiple devices cooperating together to facilitate the functionality described below.

Referring now to FIG. 2, in some embodiments, the computing device 102 establishes an environment 200 during operation. The illustrative environment 200 includes a firmware environment 202 and an operating system 204. Although the illustrative embodiment 200 includes a single operating system 204, in other embodiments the environment 200 may include more than one operating system 204 executing natively or in a virtualized manner. The various modules of the environment 200 may be embodied as hardware, firmware, software, or a combination thereof. Additionally, in some embodiments, some or all of the modules of the firmware environment 202 and/or the operating system 204 may be integrated with, or form part of, other modules or software/firmware structures.

The firmware environment 202 includes an NV store access module 206, a number of NV store policies 210, and a number of firmware driver(s)/application(s) 212. The NV store access module 206 is configured to provide controlled access services to the NV store 128, according to the NV store policies 210. As described below, the NV store access module 206 may reserve a portion of the NV store 128, preventing rogue drivers and/or applications from completely filling the NV store 128. In some embodiments, the NV store access module 206 may effectively increase the size of the NV store 128 by compressing the data stored in the NV store 128. The NV store access module 206 may provide access services to both modules included in the firmware environment 202 as well as to the operating system 204. The NV store access module 206 may implement a well-known interface including, but not limited to, the variable services defined in the UEFI specification. In some embodiments, those functions may be performed by a sub-module, for example by a compression module 208.

The NV store policies 210 include a set of rules defining allowed access to the NV store 128. One or more of the NV store policies 210 may define a minimum amount of storage space to be reserved within the NV store 128. Other policies may define whether to enable data compression. The NV store policies 210 may depend on the identity of the entity calling the access services. For example, different NV store policies 210 may apply to trusted firmware modules, the operating system 204, or untrusted applications executed by the operating system 204. The NV store policies 210 are platform-specific policies; that is, the NV store policies 210 are specific to the computing device 102. The NV store policies 210 may be generated, for example, by the manufacturer of the computing device 102, and may be stored within the NV store 128.

The firmware driver(s)/applications(s) 212 perform various tasks within the firmware environment 202. For example, the firmware driver(s)/applications(s) 212 may include hardware drivers, system configuration utilities, boot loaders, and other firmware utilities. The firmware driver(s)/applications(s) 212 may user the NV store access module 206 to access the NV store 128. Additionally, the operating system 204 may execute one or more applications(s) 214. The operating system 204 and/or the applications(s) 214 may similarly access the NV store 128 using the NV store access module 206.

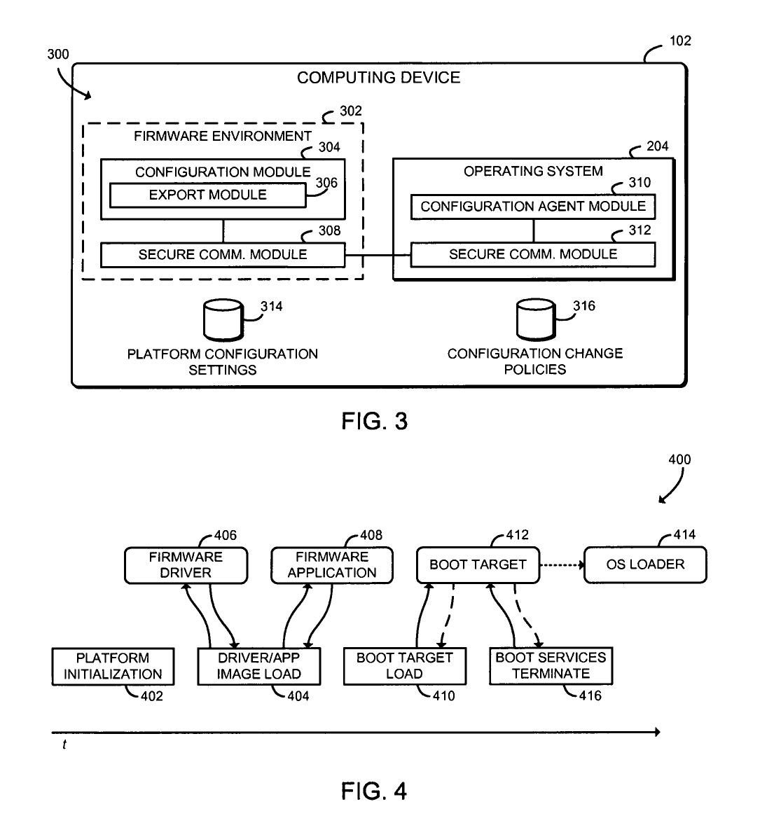

Referring now to FIG. 3, in another embodiment, the computing device 102 establishes an environment 300 during operation. The illustrative environment 300 includes a firmware environment 302, the operating system 204, platform configuration settings 314 and configuration change policies 316. Although the illustrative embodiment 300 includes a single operating system 204, in other embodiments the environment 300 may include more than one operating system 204 executing natively or in a virtualized manner. The various modules of the environment 300 may be embodied as hardware, firmware, software, or a combination thereof. Additionally, in some embodiments, some or all of the modules of the firmware environment 302 and/or the operating system 204 may be integrated with, or form part of, other modules or software/firmware structures.

The firmware environment 302 includes a configuration module 304 and a secure communication module 308. The configuration module 304 is configured to read, execute, or otherwise apply configuration directives to update the platform configuration of the computing device 102. As described below, the computing device 102 may be configured by modifying the platform configuration settings 314. The platform configuration settings 314 may be embodied as values of particular model-specific registers, I/O registers, memory addresses, or other data through which the computing device 102 may be configured using any other method of configuration. The configuration module 304 is also configured to determine platform configuration settings 314 of the computing device 102 and export those current platform configuration settings 314 to be accessible by the operating system 204. As described below, the configuration directives may be generated by the operating system 204 or received from a remote administrative server 104 using the manageability engine 134. In some embodiments, those functions may be performed by a sub-module, for example by an export module 306.

The secure communication module 308 is configured to receive and verify configuration directives. Configuration directives may be verified by verifying a digital signature that has been applied to the configuration directive. The secure communication module 308 may receive the configuration directives passed as an update capsule in memory from the operating system 204. Additionally or alternatively, the secure communication module 308 may receive the configuration directives by performing a handshake protocol with the manageability engine 134, which in turn may have received the configuration directives from the administrative server 104.

The operating system 204 includes a configuration agent module 310 and a secure communication module 312, and may include various other services, drivers, and applications (not shown). The configuration agent module 310 is configured to read the exported platform configuration settings 314 from the firmware environment 302 and determine whether the computing device 102 is configured sub-optimally based on the exported platform configuration settings 314. If sub-optimal, the configuration agent module 310 is configured to determine new configuration settings for the computing device 102. The configuration agent module 310 may reference the configuration change policies 316 to determine the new configuration settings. The configuration agent module 310 may apply the new configuration settings at runtime if possible, or may generate configuration directives that are securely communicated with the firmware environment 302. The configuration agent module 310 may reset the computing device 102 to apply configuration settings.

The secure communication module 312 is configured to transmit verified configuration directives to the firmware environment 302. The secure communication module 312 may digitally sign the configuration directives with a signature associated with the computing device 102, the operating system 204, the manufacturer of the computing device 102, or any other trusted party. As described above, the secure communication module 312 may transmit the configuration directives to the firmware environment 302 by packaging the configuration directives in an update capsule. Additionally or alternatively, in some embodiments the secure communication module 312 may transmit the exported device settings to an external administrative server 104.

Referring now to FIG. 4, in use, the computing device 102 may execute a boot process 400 according to the UEFI specification. In block 402, the computing device 102 initializes platform hardware. For example, the computing device 102 may initialize particular components required to process the firmware environments 202, 302, for example the memory 124 and the I/O subsystem 122.

In block 404, the computing device 102 loads and starts firmware images for one or more firmware drivers 406 or firmware applications 408. As described above, firmware drivers 406 and applications 408 are binary images that may be stored in a system partition of the data storage device 126. The particular drivers and applications to be loaded are platform-dependent and may be enumerated in global variables of the computing device 102, for example, in the NV store 128 of the computing device 102. The computing device 102 may enumerate the firmware drivers 406 and applications 408 to be loaded and determine a required boot order. The boot order may be based on dependencies between the firmware drivers 406 and applications 408.

Firmware drivers 406 and applications 408 are essentially the same, except that applications 408 are generally unloaded from the memory 124 after returning from their entry point, and drivers 406 generally stay resident in the memory 124 unless they return with an error code. Firmware drivers 406 and applications 408 may initialize or control hardware of the computing device 102. Firmware drivers 406 or applications 408 may also install firmware protocol interfaces, which define function call interfaces and, after being installed, allow other firmware images to invoke provided services. For example, one or more firmware drivers 406 or applications 408 may install variable services allowing client entities to get, set, and query variable information stored in the NV store 128.

In block 410, the computing device 102 determines and loads a boot target 412. A boot target 412 is a firmware application that will be loaded and started by the computing device 102. Boot targets are typically operating system loaders, although the boot target may include diagnostic, maintenance, or management applications. The particular boot target 412 selected may be specified in global variables of the computing device 102, for example stored in the NV store 128. The global variables of the computing device 102 may specify several boot targets 412, including a relative ordering of the boot targets 412. In some embodiments, the boot target 412 may be selected by a user of the computing device 102 through a menu or other means presented on the computing device 102. In some embodiments, the computing device 102 may include a default boot targets 412 or default rules for selecting a boot target 412.

In the boot target 412, the computing device 102 hands off control to an operating system loader 414. Such operating system loader 414 may not be stored in the system partition of the data storage device 126. As part of the handoff, the boot target 412 may advance to block 416 to terminate boot services, for example by calling the UEFI function ExitBootServices( ). Therefore, if such a boot target 412 is successful, the boot process 400 is complete, and the operating system 204 is in control of the computing device 102. Only firmware services that have been specifically designated as runtime-capable remain available after control has been passed to the operating system 204. If boot services are not terminated by the boot target 412, for example if the operating system loader 414 fails to load the operating system 204, the computing device 102 may attempt to load another boot target 412.

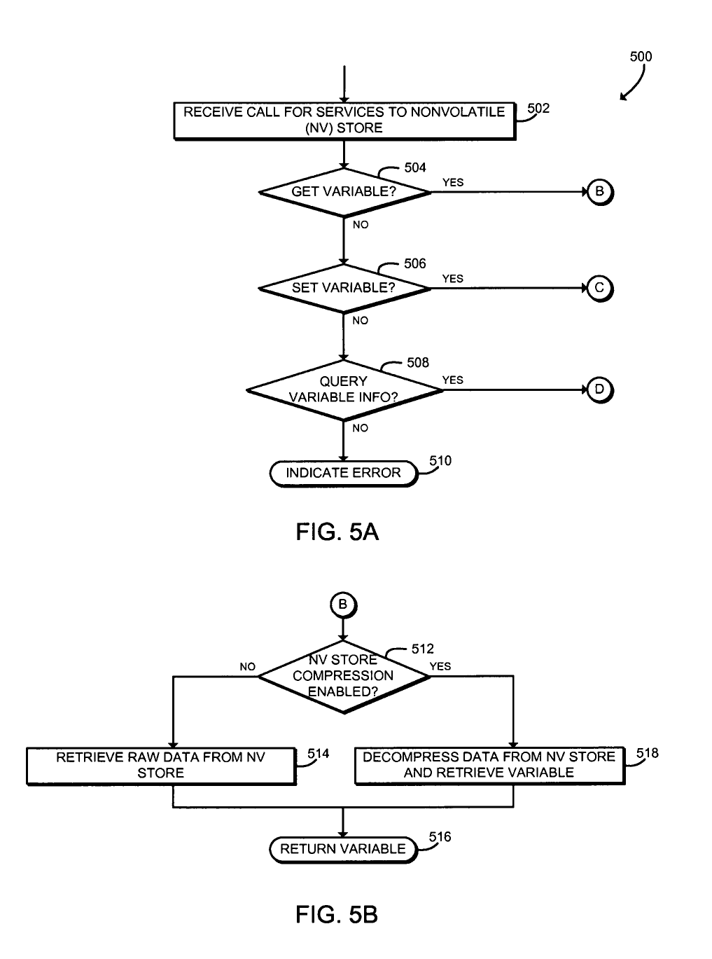

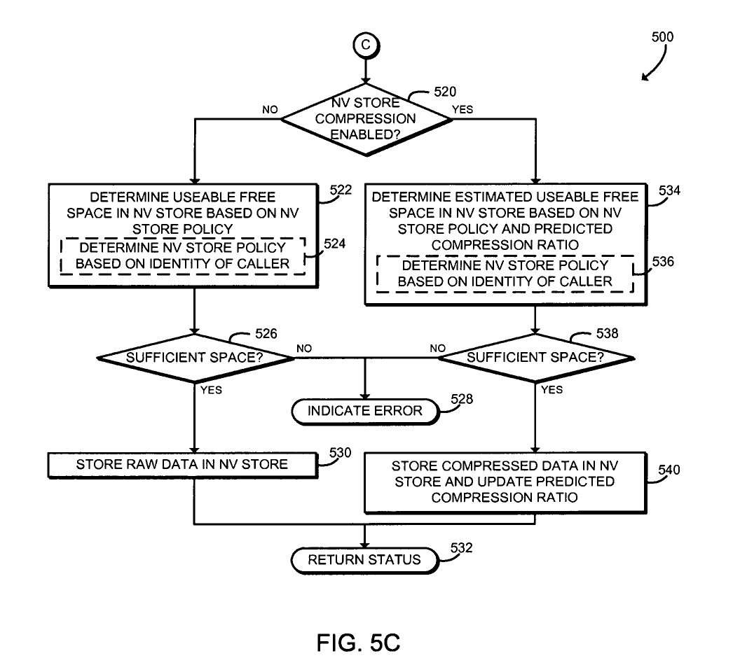

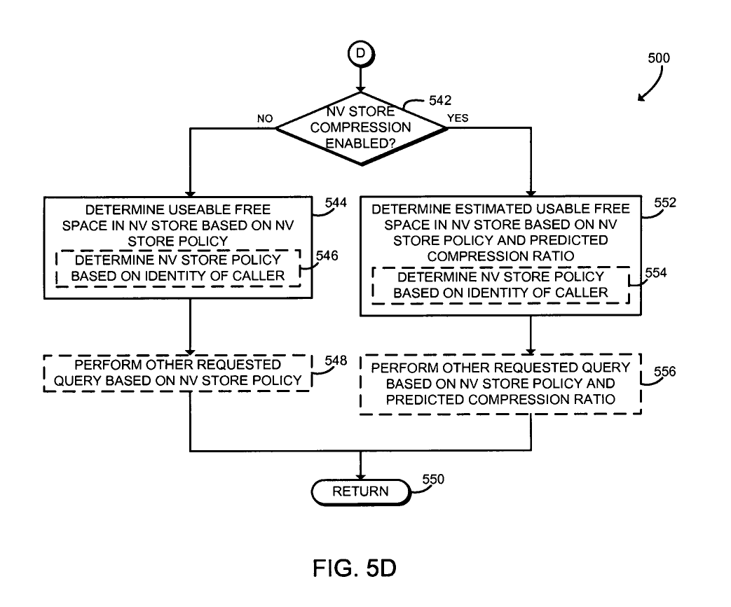

Referring now to FIG. 5A, in use, the computing device 102 may execute a method 500 for providing services to the NV store 128. The method 500 begins with block 502, in which the computing device 102 receives a call for services to the NV store 128. The call may be for access services or for other services related to the NV store 128. The call for services may be made during pre-boot by the firmware environment 202, or may be made at runtime by the operating system 204, drivers, or application software. The call for services may be performed according to a standard platform interface, such as a “C” language calling convention. The particular services may be requested according to a defined interface, such as the UEFI standard.

In block 504, the computing device 102 determines whether the caller has requested to “get” an NV store variable. This determination may be based on the interface used for calling services; for example, the computing device 102 may determine whether the UEFI function GetVariable( ) has been called. If so, the method 500 branches to block 512, described below in connection with FIG. 5B. If not, the method 500 advances to block 506.

In block 506, the computing device 102 determines whether the caller has requested to “set” an NV store variable. This determination may be based on the interface used for calling services; for example, the computing device 102 may determine whether the UEFI function SetVariable( ) has been called. If so, the method 500 branches to block 520, described below in connection with FIG. 5C. If not, the method 500 advances to block 508.

In block 508, the computing device 102 determines whether the caller has requested to “query” variable info for an NV store variable. This determination may be based on the interface used for calling services; for example, the computing device 102 may determine whether the UEFI function QueryVariableInfo( ) has been called. If so, the method 500 branches to block 542, described below in connection with FIG. 5D. If not, the method 500 advances to block 510. In block 510, the computing device 102 indicates an error to the caller, completing the method 500. For example, the computing device 102 may return an error code indicating no supported NV store service has been requested. Of course, in some embodiments the computing device 102 may handle additional services not shown in FIG. 5A. Although FIG. 5A has been illustrated and described with regard to three specific calls for services, it should be appreciated the computing device 102 may be configured to handle other or additional service calls for the NV store 128 in a similar manner.

As discussed above, if the computing device 102 determines that a “get” service has been requested in block 504, the method 500 advances to block 512 of FIG. 5B. In block 512, the computing device 102 determines whether NV store compression is enabled. In some embodiments, NV store compression may be enabled or disabled at the time of manufacture. In other embodiments, NV store compression may be configured using one or more platform configuration registers, firmware variables, or other configuration mechanisms of the computing device 102. If NV store compression is enabled, the method 500 branches to block 518, described below. If NV store compression is disabled, the method 500 branches to block 514.

In block 514, the computing device 102 retrieves raw data from the NV store 128 for the requested variable. In block 516, the computing device 102 returns the retrieved data to the caller. For example, the computing device 102 may allocate a memory buffer for the retrieved data and return a C-style pointer to the memory buffer. The computing device 102 may return the retrieved data according to a well-defined interface such as the UEFI specification.

Referring back to block 512, if NV store compression is enabled, the method 500 branches to block 518, in which the computing device 102 decompresses data from the NV store 128 and retrieves the data for the requested variable. The computing device 102 may use any suitable compression algorithm for compressing variable data in the NV store 128. For example, the computing device 102 may compress and decompress the variable data using the Lempel-Ziv-Markov algorithm (“LZMA”). After decompressing the variable data, the computing device 102 returns the decompressed data to the caller in block 516. The variable compression is transparent to the caller; for example, the computing device 102 stores the decompressed variable data in a memory buffer and returns a pointer to that buffer.

As discussed above, if the computing device 102 determines that a “set” service has been requested in block 506, the method 500 advances to block 520 of FIG. 5C. In block 520, the computing device 102 determines whether NV store compression is enabled. As described with regard to block 512 of FIG. 5B, NV store compression may be enabled or disabled at the time of manufacture, or may be configured using one or more platform configuration registers, firmware variables, or other configuration mechanisms of the computing device 102. If NV store compression is enabled, the method 500 branches to block 534, described below. If NV store compression is disabled, the method 500 branches to block 522.

In block 522, the computing device 102 determines useable free space in the NV store 128 based on the applicable NV store policy 210. As described above, each NV store policy 210 may specify a minimum amount of reserved memory in the NV store 128 that may not be allocated for variable data. For example, the NV store policy 210 may reserve 8 kilobytes out of 128 kilobytes of total storage within then NV store 128. To determine useable free space, the computing device 102 determines the raw unallocated space of the NV store 128 and subtracts the amount of reserved space. For example, given that the NV store 128 includes 128 kilobytes of storage and that 96 kilobytes of memory are allocated, the NV store 128 would include 32 kilobytes of raw unallocated space. Given a reserved segment 8 kilobytes, the useable free space would be 24 kilobytes.

In some embodiments, the computing device 102 may determine the applicable NV store policy 210 based on the identity of the caller in block 524. For example, a trusted caller provided by the manufacturer of the computing device 102 may be allowed access to additional useable free space; that is, less of the NV store 128 may be reserved for trusted callers. The computing device 102 may determine the identity of the caller using any suitable methodology. In some embodiments, the computing device 102 may determine the identity of the caller by examining the system stack to determine a return address pointing to the memory location of the caller. For example, the computing device 102 may determine if the caller is a trusted firmware driver or application, the operating system 204, an application or driver of the operating system 204, or other entity based on the calling address.

In block 526, the computing device 102 determines whether sufficient space exists in the NV store 128 to store the requested variable. The computing device 102 may compare the amount of data passed by the caller to the useable free space determined in block 522. If sufficient space is not available, the method 500 branches to block 528, in which the computing device 102 indicates error to the caller. The computing device 102 may return an error code, raise an exception, send a signal, or perform another platform-appropriate method to indicate the error. If sufficient space is available in the NV store 128, the method 500 advances to block 530.

In block 530, the computing device 102 stores the raw data provided by the caller in the NV store 128. The computing device 102 associates the raw data with the specified variable, to allow the data to be retrieved later. After storing the raw data, the method 500 advances to block 532, in which the method 500 returns a successful status code to the caller.

Referring back to block 520, if NV store compression is enabled, the method 500 branches to block 534. In block 534, the computing device 102 determines the estimated useable free space in the NV store 128 based on the applicable NV store policy 210 and a predicted compression ratio. The predicted compression ratio may be predetermined, or may be based on the compression ratio of variable data previously stored in the NV store 128. The computing device 102 may determine an amount of raw unallocated space in the NV store 128 and apply the predicted compression ratio to determine a predicted logical unallocated space. The computing device 102 may subtract the amount of reserved space specified by the NV store policy 210 from the logical unallocated space to determine the estimated useable free space. For example, assume that the NV store 128 includes 32 kilobytes of raw unallocated space. The computing device 102 may estimate a larger logical unallocated space based on the predicted compression ratio, for example 64 kilobytes. Given a reserved segment 8 kilobytes as specified by the NV store policy 210, the estimated useable free space in that example would be 56 kilobytes.

In some embodiments, in block 536 the computing device 102 may determine the applicable NV store policy 210 based on the identity of the caller. For example, a trusted caller provided by the manufacturer of the computing device 102 may be allowed access to additional useable free space; that is, less of the NV store 128 may be reserved for trusted callers. As described above, the computing device 102 may determine the identity of the caller using any suitable methodology such as by examining the system stack to determine a return address pointing to the memory location of the caller. For example, the computing device 102 may determine if the caller is a trusted firmware driver or application, the operating system 204, an application or driver of the operating system 204, or other entity based on the calling address.

In block 538, the computing device 102 determines whether sufficient space exists in the NV store 128 to store the requested variable. The computing device 102 may compare the amount of data passed by the caller to the estimated useable free space determined in block 522. In other embodiments, the computing device 102 may perform a different algorithm to make that determination, for example, compressing the requested variable data and determining if sufficient raw space in the NV store 128 is available for the compressed data. If sufficient space is not available, the method 500 branches to block 528, in which the computing device 102 indicates error to the caller. The computing device 102 may return an error code, raise an exception, send a signal, or perform another platform-appropriate method to indicate the error. If sufficient space is available in the NV store 128, the method 500 advances to block 540.

In block 540, the computing device 102 compresses the variable data provided by the caller and stores the compressed data in the NV store 128. The computing device 102 associates the compressed data with the specified variable, to allow the data to be retrieved later. The computing device 102 may also update the predicted compression ratio based on the actual compression ratio achieved for the variable data, to improve accuracy of free space estimates. After storing the compressed data, the method 500 advances to block 532, in which the method 500 returns a successful status code to the caller.

As discussed above, if the computing device 102 determines that a “query” service has been requested in block 506, the method 500 advances to block 542 of FIG. 5D. In block 542, the computing device 102 determines whether NV store compression is enabled. As described above, NV store compression may be enabled or disabled at the time of manufacture, or may be configured using one or more platform configuration registers, firmware variables, or other configuration mechanisms of the computing device 102. If NV store compression is enabled, the method 500 branches to block 552, described below. If NV store compression is disabled, the method 500 branches to block 544.

In block 544, the computing device 102 determines useable free space in the NV store 128 based on the applicable NV store policy 210. As described above, the NV store policy 210 may specify a minimum amount of reserved memory in the NV store 128 that may not be allocated for variable data. For example, the NV store policy 210 may reserve 8 kilobytes out of 128 kilobytes of total storage within then NV store 128. To determine useable free space, the computing device 102 determines the raw unallocated space of the NV store 128 and subtracts the amount of reserved space. In some embodiments, in block 546 the computing device 102 may determine the applicable NV store policy 210 based on the identity of the caller. For example, a trusted caller provided by the manufacturer of the computing device 102 may be allowed access to additional useable free space; that is, less of the NV store 128 may be reserved for trusted callers. The computing device 102 may determine the identity of the caller using any suitable methodology such as by examining the system stack to determine a return address pointing to the memory location of the caller. For example, the computing device 102 may determine if the caller is a trusted firmware driver or application, the operating system 204, an application or driver of the operating system 204, or other entity based on the calling address.

In block 548, in some embodiments the computing device 102 may perform another requested query based on the NV store policy 210. For example, the computing device 102 may determine the maximum size of an individual variable stored in the NV store 128. After performing the requested queries, the method 500 advances to block 550, in which the method 500 returns the query information, including useable free space, to the caller.

Referring back to block 542, if NV store compression is enabled, the method 500 branches to block 552. In block 552, the computing device 102 determines the estimated useable free space in the NV store 128, based on the applicable NV store policy 210 and the predicted compression ratio. As described above, the computing device 102 may determine an amount of raw unallocated space in the NV store 128 and apply the predicted compression ratio to determine a predicted logical unallocated space. The computing device 102 may subtract the amount of reserved space specified by NV store policy 210 from the logical unallocated space to determine the estimated useable free space.

In some embodiments, in block 554 the computing device 102 may determine the applicable NV store policy 210 based on the identity of the caller. For example, a trusted caller provided by the manufacturer of the computing device 102 may be allowed access to additional useable free space; that is, less of the NV store 128 may be reserved for trusted callers. As described above, the computing device 102 may determine the identity of the caller using any suitable methodology such as by examining the system stack to determine a return address pointing to the memory location of the caller. For example, the computing device 102 may determine if the caller is a trusted firmware driver or application, the operating system 204, an application or driver of the operating system 204, or other entity based on the calling address.

In block 556, in some embodiments the computing device 102 may perform another requested query based on the NV store policy 210 and the predicted compression ratio. For example, the computing device 102 may determine the maximum size of an individual variable stored in the NV store 128. After performing the requested queries, the method 500 advances to block 550, in which the method 500 returns the query information, including useable free space, to the caller.

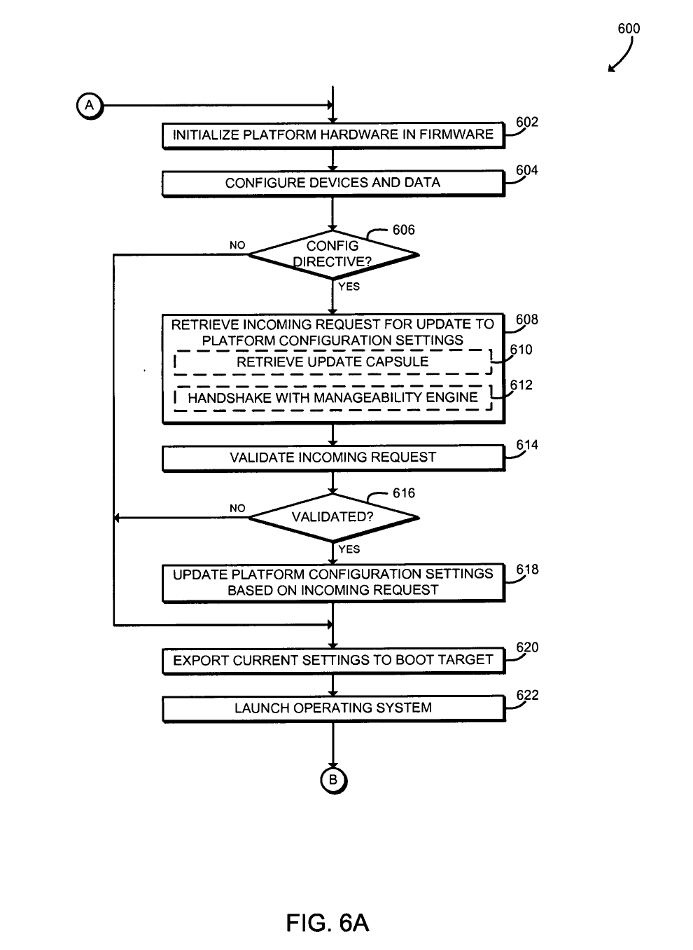

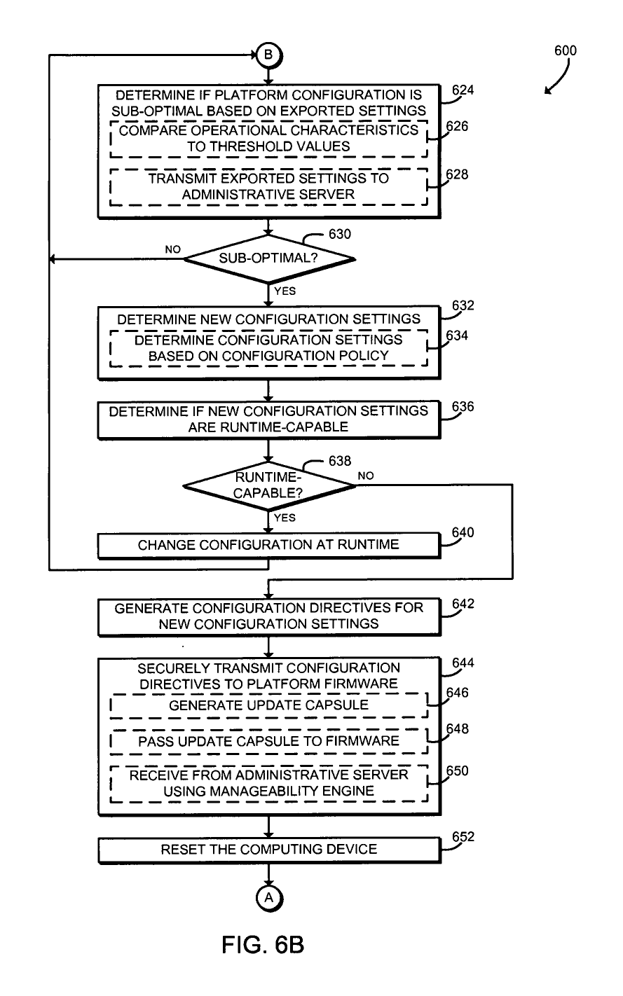

Referring now to FIG. 6A, in use, the computing device 102 may execute a method 600 for platform configuration in addition to, or in place of, the method 500 described above. The method 600 begins with block 602, in which the computing device 102 initializes platform hardware from the firmware environment 302. For example, the computing device 102 may initialize critical hardware components such as the processor 120, the memory 124, and/or the I/O subsystem 122. This initialization is performed at boot time, either when the computing device 102 is first powered on, or when the computing device 102 is rebooted. In block 604, the computing device 102 configures attached devices and data. Configured devices may include peripheral or optional components of the computing device 102. The computing device 102 may query various interconnect buses or device interfaces to determine attached devices and configuration data. The computing device 102 may read various registers, memory addresses, or otherwise populate the platform configuration settings 314.

In block 606, the computing device 102 determines whether one or more configuration directives are available to the firmware environment 302. As described below, configuration directives may be created and passed to the firmware environment 302 by an agent of the operating system 204 or by the manageability engine 134. If no configuration directives are available, the method 600 branches ahead to block 620, as described below. If configuration directives are available, the method 600 advances to block 608.

In block 608, the computing device 102 retrieves one or more incoming requests to update the platform configuration settings 314. The request to update platform settings may identify a particular platform configuration setting as well as the requested new value of the platform configuration setting. For example, the request to update settings may specify a particular model-specific register, I/O register, or memory address. Additionally, the request may specify a particular bit field within the associated register or address, along with the requested new value of that bit field. The new platform configuration setting may enable, disable, or otherwise configure platform-specific features of the computing device 102, for example a hardware prefetcher of the processor 120, or a memory interleave setting for the memory 124.

The incoming request may be stored or passed in any manner accessible to the firmware environment 302 of the computing device 102. In some embodiments, in block 610 the computing device retrieves an update capsule that has been created by the computing device 102 at runtime. As described below, the operating system 204 of the computing device 102 may operate in protected mode, addressing data in memory using a virtual or linear addressing mode. The firmware environment 302, on the other hand, may operate in real mode, addressing memory using physical addresses. To transfer data in memory from the operating system 204 to the firmware environment 302, an update capsule may be generated that includes a mapping between virtual and physical memory addresses containing the transferred data. For example, the operating system 204 may call the UpdateCapsule( ) UEFI function to pass data to the firmware environment 302 for processing. The firmware environment 302 may retrieve and process the update capsule by querying the UEFI system table for a reference to the capsule. In some embodiments, in block 612 the computing device 102 may perform a handshake protocol with the manageability engine 134 to retrieve the incoming requests. The computing device 102 may connect with the manageability engine 134 using a well-defined network port.

In block 614, the computing device 102 validates the incoming requests. The computing device 102 may perform any validation procedure capable of verifying the source of the incoming requests and/or that the incoming requests have not been tampered with. For example, the computing device 102 may validate one or more digital signatures associated with the incoming requests. In block 616, the computing device 102 determines whether the incoming request has been successfully validated. If not, the method 600 branches ahead to block 620, as described below. If successfully validated, the method 600 advances to block 618.

In block 618, the computing device 102 updates the platform configuration settings 314 based on the incoming requests. The computing device 102 may set appropriate values for model-specific registers, I/O registers, memory addresses, or perform other configuration operations as specified by the incoming requests.

In block 620, the computing device 102 exports the current platform configuration settings 314 to the boot target. Exporting the current settings allows the operating system 204 to access the platform configuration settings 314 after boot is complete and after boot services have been terminated. Such configuration settings may not be accessible to the operating system 204 after boot unless exported by the firmware environment 302. To perform the export, the computing device 102 may make the information available in the UEFI system table, in nonvolatile platform variables, in the data storage device 126, or using any other communication method available to the operating system 204.

In block 622, the computing device 102 launches the operating system 204. The computing device 102 may select an appropriate boot target from a number of available boot targets pursuant to the UEFI specification. Certain platform configuration settings 314 may become locked, read-only, or otherwise not configurable after loading the operating system 204. After loading the operating system 204, the method 600 advances to block 624, illustrated in FIG. 6B.

In block 624, the computing device 102 determines whether the platform configuration of the computing device 102 is sub-optimal based on the platform configuration settings 314 exported from the firmware environment 302. In other words, the computing device 102 determines whether the configuration settings of the computing device 102 may be changed to improve the performance of the computing device 102. To determine whether the computing device 102 is configured sub-optimally, the computing device 102 may compare the configuration settings to a set of known configuration settings. Additionally or alternatively, in some embodiments, the computing device 102 may compare operational characteristics to predefined threshold values in block 626. The computing device 102 may determine the operational characteristics by measuring or otherwise profiling platform performance during operation. The particular operational characteristic(s) used by the computing device 102 may be embodied as any operational characteristic(s) of the computing device 102 that is indicative of the operational performance of the computing device 102. For example, the computing device 102 may measure memory latency and/or bandwidth during operation. The determination of whether the platform configuration is sub-optimal may be performed by an agent resident in the operating system 204, for example by an operating system driver.

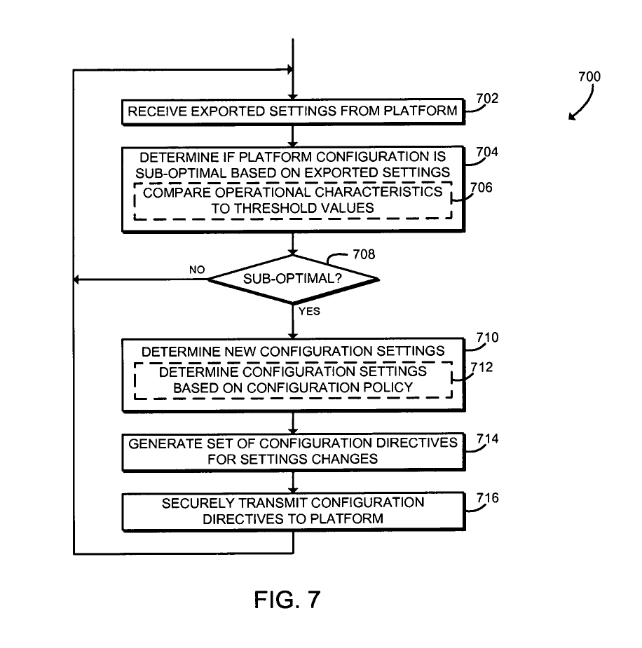

In some embodiments, in block 628, the computing device 102 transmits the exported platform configuration settings 314 to an administrative server 104. In such embodiments, the administrative server 104 may make the determination of whether the platform is sub-optimally configured, as described below in connection with FIG. 7. The computing device 102 may transmit the configuration settings using an operating system agent or application executed by the processor 120. Additionally or alternatively, in some embodiments the configuration settings may be transmitted using the out-of-band network communication capability of the manageability engine 134. That is, the configuration settings may be transmitted by the manageability engine 134 regardless of the status of any operating system 204 or applications executed by the processor 120.

In block 630, the computing device 102 determines whether the platform configuration is sub-optimal. If not—that is, if the platform configuration is optimal or the computing device 102 has not identified the configuration as being sub-optimal—the method 600 loops back to block 624 to continue monitoring the platform configuration. In that manner, the computing device 102 may adapt to changing conditions and ensure the computing device 102 remains optimally configured. If the computing device 102 has been determined to be sub-optimal, the method 600 advances to block 632.

In block 632, the computing device 102 determines new configuration settings to make the platform configuration more optimal. The new configuration settings may include new values for model-specific registers, I/O registers, memory addresses, or any other configuration setting for the computing device 102. In some embodiments, the configuration settings may correspond to particular bit fields within the registers or memory locations. Each of the new configuration settings may correspond to a platform configuration setting 314 exported by the firmware environment 302. In some embodiments, in block 634 the computing device 102 may determine the new configuration setting based on one or more configuration change policies 316. The configuration change policies 316 may be embodied as a set of rules defining new configuration settings based on particular performance problems. For example, a configuration change policy may indicate that the hardware prefetcher should be enabled to improve memory bandwidth and/or latency. Additionally or alternatively, the configuration change policies 316 may be embodied as a set of platform configuration settings 314 known to be appropriate for particular hardware components and/or combinations of hardware components.

In block 636, the computing device 102 determines whether the configuration settings may be changed at runtime. Certain low-level configuration settings, for example memory interleave, may only be configured by the firmware environment 302 during boot. The computing device 102 may maintain a list of the platform configuration settings 314 that are runtime capable and those that are not. In block 634, if the changes are not runtime-capable, the method 600 branches to block 642, described below. If the changes are runtime capable, the method 600 advances to block 640.

In block 640, the computing device 102 changes the platform configuration settings 314 at runtime. The configuration change may occur substantially immediately, or may be scheduled for a convenient time. To perform the configuration changes, the computing device 102 may set appropriate values for model-specific registers, I/O registers, memory addresses, or perform other configuration operations as determined in block 632. After changing the platform configuration, the method 600 loops back to block 624, to continue monitoring for sub-optimal platform configuration.

Referring back to block 638, if the changes are not runtime-capable, the method 600 branches to block 642. In block 642, the computing device 102 generates one or more configuration directives for the new configuration settings. As described above, each configuration directive may be interpreted or executed by the firmware environment 302 in order to change the platform configuration settings 314 during boot.

In block 644, the computing device 102 securely passes the configuration directives to the firmware environment 302. In some embodiments, the computing device 102 may digitally sign the configuration directives, allowing the firmware environment 302 to verify the source of the configuration directives. In some embodiments, the computing device 102 may also communicate the configuration directives to the firmware environment 302 using a secure or encrypted channel. In some embodiments, in block 646 the computing device 102 may generate an update capsule including the configuration directives. As described above, the update capsule may be embodied as a block of data stored in protected-mode virtual memory. The configuration directives may be stored within the update capsule using any format readable by the firmware environment 302 and/or the configuration module 304. In some embodiments, in block 648 the computing device 102 may pass the update capsule to the firmware environment 302. As described above, to pass data in memory from the operating system 204 to the firmware environment 302, a mapping between the virtual memory addresses used by the operating system 204 to physical addresses used by the firmware environment 302 may be generated. For example, the UpdateCapsule( ) UEFI function may be used to pass the update capsule and the memory mapping to the firmware environment 302 for processing.

In block 650, in some embodiments the computing device 102 may receive the configuration directives from the administrative server 104 using the manageability engine 134. The administrative server 104 may digitally sign and/or encrypt the configuration directives, allowing the computing device 102 to validate the configuration directives. The manageability engine 134 may store the configuration directives until queried by the firmware environment 302 during a handshake protocol, as described above. Further, although illustrated as being executed during the method 600, the manageability engine 134 is capable of out-of-band network communications, allowing configuration directives to be received from the administrative server 104 regardless of the state of the processor 120 or the operating system 204. Accordingly, the manageability engine 134 may receive configuration directives from the administrative server 104 at any time, and store the configuration directives until needed.

In block 652, the computing device 102 is reset. The computing device 102 may reset itself using a standard interface such as the ResetSystem( ) UEFI function or the advanced configuration and power interface (“ACPI”) reset command. In some embodiments, for example when the configuration directives are to be passed as an update capsule to the firmware environment 302, the computing device 102 may perform a warm reset that does not clear the contents of memory. In some embodiments, for example when a configuration directive has been received by the manageability engine 134 from the administrative server 104, the computing device 102 may be reset by the user. After reset, the method 600 loops back to block 602, shown in FIG. 6A, to re-initialize the platform and update the configuration settings according to the configuration directives.

Referring now to FIG. 7, in use, the administrative server 104 may execute a method 700 for platform configuration. The method 700 begins with block 702, in which the administrative server 104 receives exported platform configuration settings 314 from a computing device 102. As described above, the exported platform configuration settings 314 are generated by the firmware environment 302 of the computing device, and may be transmitted by the operating system 204 of the computing device 102, or by the manageability engine 134 of the computing device 102. Although illustrated as receiving configuration settings from a single computing device 102, in many embodiments the administrative server 104 may receive configuration settings for numerous computing devices 102, for example, for all of the computing devices 102 used by an organization.

In block 704, the administrative server 104 determines whether the platform configuration of the computing device 102 is sub-optimal, based on the exported platform configuration settings 314. To determine whether the platform is configured sub-optimally, the administrative server 104 may compare the configuration settings to a set of known configuration settings. In some embodiments, in block 706 the administrative server 104 may compare operational characteristics of the computing device 102 to predefined threshold values. To determine the operational characteristics, the administrative server 104 may receive measurement or profile information from the computing device 102. By monitoring numerous computing devices 102, the administrative server 104 may be able to detect common misconfigurations. In block 708, the administrative server 104 determines whether the platform configuration is sub-optimal. If not, the method 700 loops back to block 702 to continue monitoring the computing device 102. If the platform configuration is sub-optimal, the method 700 advances to block 710.

In block 710, the administrative server 104 determines new configuration settings to make the platform configuration of the computing device 102 more optimal. The new configuration settings may include new values for model-specific registers, I/O registers, memory addresses, or any other configuration setting specific to the computing device 102. In some embodiments, the configuration settings may correspond to particular bit fields within the registers or memory locations. Each of the new configuration settings may correspond to a platform configuration setting 314 exported by the firmware environment 302. In some embodiments, in block 712 the administrative server 104 may determine the new configuration setting based on one or more configuration change policies 316. As described above, the configuration change policies 316 may be embodied as a set of rules defining new configuration settings based on particular performance problems. For example, a configuration change policy may indicate that the hardware prefetcher should be enabled to improve memory bandwidth and/or latency. Additionally or alternatively, the configuration change policies 316 may be embodied as a set of platform configuration settings 314 known to be appropriate for particular hardware components and/or combinations of hardware components.

In block 714, the administrative server 104 generates one or more configuration directives for the new configuration settings. Each configuration directive may be interpreted or executed by the firmware environment 302 of the computing device 102, in order to change the platform configuration settings 314 during boot. Configuration directives generated by the administrative server 104 may be performed exclusively during boot; therefore, the administrative server 104 may not determine whether the configuration changes are runtime-capable.

In block 716, the administrative server 104 transmits the configuration settings to the computing device 102. As described above, the configuration settings may be received by the operating system 204 or an application executed by the processor 120, or by the manageability engine 134. The configuration directives may be transmitted to the manageability engine 134 regardless of the status of the processor 120 or the operating system 204, because the manageability engine 134 has out-of-band network communication capability. As described above, when transmitted to the manageability engine 134, the configuration directives may become effective when the computing device 102 is next reset. After transmitting the configuration directives, the method 700 loops back to block 702 to continue monitoring the computing device 102.

### Examples

Illustrative examples of the technologies disclosed herein are provided below. An embodiment of the technologies may include any one or more, and any combination of, the examples described below.

Example 1 includes a computing device for providing services to a data store, the computing device comprising a non-volatile store to store one or more variables; a non-volatile store policy that defines a minimum amount of reserved space in the non-volatile store; and a non-volatile store access module to (i) receive a call for services to the non-volatile store, (ii) determine usable free space in the non-volatile store based on the non-volatile store policy, and (iii) respond to the call for services based on the usable free space in the non-volatile store.

Example 2 includes the subject matter of Example 1, and wherein the non-volatile store access module is established by a firmware environment of the computing device.

Example 3 includes the subject matter of any of Examples 1 and 2, and wherein to determine the usable free space further comprises to determine an identity of a caller of the call for services; and determine the usable free space based on the non-volatile store policy and the identity of the caller; wherein the non-volatile store policy further defines an amount of reserved space based on the identity of the caller.

Example 4 includes the subject matter of any of Examples 1-3, and wherein to determine the identity of the caller comprises to analyze a return address stored in a system stack of the computing device.

Example 5 includes the subject matter of any of Examples 1-4, and wherein the call for services comprises a call to set a variable in the non-volatile store; and to respond to the call for services comprises to determine whether the usable free space is sufficient to store the variable; and store the variable in the non-volatile store in response to a determination that the useable free space is sufficient.

Example 6 includes the subject matter of any of Examples 1-5, and wherein to determine the usable free space comprises to determine the usable free space based on a physical free space of the non-volatile store and a predicted compression ratio of the non-volatile store; and to store the variable further comprises to: compress the variable to produce compressed variable data; store the compressed variable data in the non-volatile store; and update the predicted compression ratio based on the compressed variable data.

Example 7 includes the subject matter of any of Examples 1-6, and wherein the call for services comprises a call to set a variable in the non-volatile store; and to respond to the call for services comprises to: determine whether the usable free space is sufficient to store the variable; and indicate an error to a caller of the call to set the variable in response to a determination that the useable free space is not sufficient.

Example 8 includes the subject matter of any of Examples 1-7, and wherein to determine the usable free space comprises to determine the usable free space based on a physical free space of the non-volatile store and a predicted compression ratio of the non-volatile store.

Example 9 includes the subject matter of any of Examples 1-8, and wherein the call for services comprises a call to query information for a variable stored in the non-volatile store; and to respond to the call for services comprises to return the usable free space to a caller of the call to query information.

Example 10 includes the subject matter of any of Examples 1-9, and wherein to determine the usable free space comprises to determine the usable free space based on a physical free space of the non-volatile store and a predicted compression ratio of the non-volatile store.

Example 11 includes a computing device for platform configuration, the computing device comprising a configuration module established by a firmware environment of the computing device, the configuration module to (i) determine information on a configuration setting of the computing device that is inaccessible to an operating system of the computing device, and (ii) export the information on the configuration setting, such that the exported information is accessible to the operating system; and a configuration agent module established by the operating system, the configuration agent module to (i) determine a new configuration setting for the computing device based on the exported information, and (ii) configure the computing device using the new configuration setting.

Example 12 includes the subject matter of Example 11, and wherein the configuration setting comprises a platform-specific configuration setting.

Example 13 includes the subject matter of any of Examples 11 and 12, and wherein the platform-specific configuration setting comprises one of a hardware prefetcher enable setting, a memory interleave setting, a model-specific register value, or a chipset register value.

Example 14 includes the subject matter of any of Examples 11-13, and wherein to export the information comprises to update a system table to reference the information; and pass the system table to a boot target to boot the operating system.

Example 15 includes the subject matter of any of Examples 11-14, and wherein to determine the new configuration setting comprises to compare an operational characteristic of the computing device to a predefined threshold value; and determine the new configuration setting based on the comparison of the operational characteristic to the predefined threshold value.

Example 16 includes the subject matter of any of Examples 11-15, and wherein the configuration agent module is further to determine whether the new configuration setting can be configured at runtime; in response to a determination that the new configuration setting can be configured at runtime, configure the computing device based on the new configuration setting; and in response to a determination that the new configuration setting cannot be configured at runtime: (i) generate a configuration directive based on the new configuration setting and (ii) reset the computing device; wherein the computing device further comprises a first secure communication module established by the operating system, the first secure communication module to securely pass the configuration directive from the operating system to the firmware environment prior to the reset of the computing device; wherein the computing device further comprises a second secure communication module established by the firmware environment, the second secure communication module to (i) receive the configuration directive in response to the reset of the computing device and (ii) validate the configuration directive; and wherein the configuration module established by the firmware environment is further to configure the computing device based on the new configuration setting in response to validation of the configuration directive.

Example 17 includes the subject matter of any of Examples 11-16, and wherein to securely pass the configuration directive from the operating system to the firmware environment comprises to pass an update capsule from the operating system to the firmware environment, the update capsule to include the configuration directive; and to receive the configuration directive comprises to process the update capsule.

Example 18 includes the subject matter of any of Examples 11-17, and wherein to securely pass the configuration directive comprises to digitally sign the configuration directive; and to validate the configuration directive comprises to verify a digital signature of the configuration directive.

Example 19 includes a computing device for platform configuration, the computing device comprising an out-of-band processor to receive a configuration directive from an administrative server, the configuration directive to define a new configuration setting for a configuration setting of the computing device not accessible by an operating system of the computing device; a secure communication module established by a firmware environment of the computing device, the secure communication module to (i) receive the configuration directive from the out-of-band processor, and (ii) validate the configuration directive; and a configuration module established by the firmware environment, the configuration module to configure the computing device using the new configuration setting in response to validation of the configuration directive.

Example 20 includes the subject matter of Example 19, and wherein the new configuration setting comprises a platform-specific configuration setting.

Example 21 includes the subject matter of any of Examples 19 and 20, and wherein the platform-specific configuration setting comprises one of a hardware prefetcher enable setting, a memory interleave setting, a model-specific register value, or a chipset register value.

Example 22 includes the subject matter of any of Examples 19-21, and wherein to validate the configuration directive comprises to perform a handshake protocol with the out-of-band processor.

Example 23 includes the subject matter of any of Examples 19-22, and wherein to validate the configuration directive comprises to verify a digital signature of the configuration directive.

Example 24 includes the subject matter of any of Examples 19-23, and wherein the configuration module is further to determine information on the configuration setting of the computing device that is inaccessible to the operating system; and export the information on the configuration setting of the computing device, such that the exported information is accessible to the operating system; wherein the computing device further comprises a configuration agent module established by the operating system, the configuration agent module to transmit the exported information on the configuration setting of the computing device to the administrative server, wherein the new configuration setting is based on the transmitted information.

Example 25 includes a method for providing services to a data store, the method comprising receiving, by a computing device, a call for services to a non-volatile store of the computing device; determining, by the computing device, usable free space in the non-volatile store based on a non-volatile store policy, the non-volatile store policy defining a minimum amount of reserved space in the non-volatile store; and responding, by the computing device, to the call for services based on the usable free space in the non-volatile store.

Example 26 includes the subject matter of Example 25, and wherein determining the usable free space further comprises determining an identity of a caller of the call for services; and determining the usable free space based on the non-volatile store policy and the identity of the caller, the non-volatile store policy defining an amount of reserved space based on the identity of the caller.

Example 27 includes the subject matter of any of Examples 25 and 26, and wherein determining the identity of the caller comprises analyzing a return address stored in a system stack of the computing device.

Example 28 includes the subject matter of any of Examples 25-27, and wherein receiving the call for services comprises receiving a call to set a variable in the non-volatile store; and responding to the call for services comprises determining whether the usable free space is sufficient to store the variable; and storing the variable in the non-volatile store in response to determining the useable free space is sufficient.

Example 29 includes the subject matter of any of Examples 25-28, and wherein determining the usable free space comprises determining the usable free space based on a physical free space of the non-volatile store and a predicted compression ratio of the non-volatile store; and storing the variable further comprises compressing the variable to produce compressed variable data; storing the compressed variable data in the non-volatile store; and updating the predicted compression ratio based on the compressed variable data.

Example 30 includes the subject matter of any of Examples 25-29, and wherein receiving the call for services comprises receiving a call to set a variable in the non-volatile store; and responding to the call for services comprises determining whether the usable free space is sufficient to store the variable; and indicating an error to a caller of the call to set the variable in response to determining the useable free space is not sufficient.

Example 31 includes the subject matter of any of Examples 25-30, and wherein determining the usable free space comprises determining the usable free space based on a physical free space of the non-volatile store and a predicted compression ratio of the non-volatile store.

Example 32 includes the subject matter of any of Examples 25-31, and wherein receiving the call for services comprises receiving a call to query information for a variable stored in the non-volatile store; and responding to the call for services comprises returning the usable free space to a caller of the call to query information.

Example 33 includes the subject matter of any of Examples 25-32, and wherein determining the usable free space comprises determining the usable free space based on a physical free space of the non-volatile store and a predicted compression ratio of the non-volatile store.

Example 34 includes a method for platform configuration, the method comprising determining, by a firmware environment of a computing device, information on a configuration setting of the computing device that is inaccessible to an operating system of the computing device; exporting, by the firmware environment, the information on the configuration setting, such that the exported information is accessible to the operating system; determining, by the operating system, a new configuration setting for the computing device based on the exported information; and configuring, by the operating system, the computing device using the new configuration setting.

Example 35 includes the subject matter of Example 34, and wherein the configuration setting comprises a platform-specific configuration setting.

Example 36 includes the subject matter of any of Examples 34 and 35, and wherein the platform-specific configuration setting comprises one of a hardware prefetcher enable setting, a memory interleave setting, a model-specific register value, or a chipset register value.

Example 37 includes the subject matter of any of Examples 34-36, and wherein exporting the information comprises updating, by the firmware environment, a system table to reference the information; and passing, by the firmware environment, the system table to a boot target to boot the operating system.

Example 38 includes the subject matter of any of Examples 34-37, and wherein determining the new configuration setting comprises comparing an operational characteristic of the computing device to a predefined threshold value; and determining the new configuration setting based on comparing the operational characteristic to the predefined threshold value.

Example 39 includes the subject matter of any of Examples 34-38, and further including determining, by the operating system, whether the new configuration setting can be configured at runtime; in response to determining that the new configuration setting cannot be configured at runtime: generating, by the operating system, a configuration directive based on the new configuration setting; securely passing the configuration directive from the operating system to the firmware environment; resetting the computing device; receiving, by the firmware environment, the configuration directive in response to resetting the computing device; validating, by the firmware environment, the configuration directive; and configuring, by the firmware environment, the computing device based on the new configuration setting in response to validating the configuration directive; wherein configuring the computing device based on the new configuration setting comprises configuring the computing device based on the new configuration setting in response to determining that the new configuration setting can be configured at runtime.

Example 40 includes the subject matter of any of Examples 34-39, and wherein securely passing the configuration directive from the operating system to the firmware environment comprises passing an update capsule from the operating system to the firmware environment, the update capsule to include the configuration directive; and receiving the configuration directive comprises processing the update capsule.

Example 41 includes the subject matter of any of Examples 34-40, and wherein securely passing the configuration directive comprises digitally signing the configuration directive; and validating the configuration directive comprises verifying a digital signature of the configuration directive.

Example 42 includes a method for platform configuration, the method comprising receiving, by an out-of-band processor of a computing device, a configuration directive from an administrative server, the configuration directive defining a new configuration setting for a configuration setting of the computing device not accessible by an operating system of the computing device; receiving, by a firmware environment of the computing device, the configuration directive from the out-of-band processor; validating, by the firmware environment, the configuration directive; and configuring, by the firmware environment, the computing device using the new configuration setting in response to validating the configuration directive.

Example 43 includes the subject matter of Example 42, and wherein the new configuration setting comprises a platform-specific configuration setting.

Example 44 includes the subject matter of any of Examples 42 and 43, and wherein the platform-specific configuration setting comprises one of a hardware prefetcher enable setting, a memory interleave setting, a model-specific register value, or a chipset register value.

Example 45 includes the subject matter of any of Examples 42-44, and wherein validating the configuration directive comprises performing a handshake protocol with the out-of-band processor.

Example 46 includes the subject matter of any of Examples 42-45, and wherein validating the configuration directive comprises verifying a digital signature of the configuration directive.

Example 47 includes the subject matter of any of Examples 42-46, and further including determining, by the computing device, information on the configuration setting of the computing device that is inaccessible to the operating system; and transmitting, by the computing device, the information on the configuration setting of the computing device to the administrative server, wherein the new configuration setting is based on the transmitted information.

Example 48 includes the subject matter of any of Examples 42-47, and further including exporting, by the firmware environment, the information on the configuration setting of the computing device, such that the exported information is accessible to the operating system; wherein transmitting the information comprises transmitting the exported information by the operating system.

Example 49 includes a computing device comprising a processor; and a memory having stored therein a plurality of instructions that when executed by the processor cause the computing device to perform the method of any of Examples 25-48.

Example 50 includes one or more machine readable storage media comprising a plurality of instructions stored thereon that in response to being executed result in a computing device performing the method of any of Examples 25-48.

Example 51 includes a computing device comprising means for performing the method of any of Examples 25-48.

1-25. (canceled)

26. A computing device for providing services to a data store, the computing device comprising:
a non-volatile store to store one or more variables;
a non-volatile store policy that defines a minimum amount of reserved space in the non-volatile store; and
a non-volatile store access module to (i) receive a call for services to the non-volatile store, (ii) determine usable free space in the non-volatile store based on the non-volatile store policy, and (iii) respond to the call for services based on the usable free space in the non-volatile store.

27. The computing device of claim 26, wherein the non-volatile store access module is established by a firmware environment of the computing device.

28. The computing device of claim 26, wherein to determine the usable free space further comprises to:
determine an identity of a caller of the call for services; and
determine the usable free space based on the non-volatile store policy and the identity of the caller;
wherein the non-volatile store policy further defines an amount of reserved space based on the identity of the caller.

29. The computing device of claim 26, wherein:
the call for services comprises a call to set a variable in the non-volatile store; and
to respond to the call for services comprises to:
determine whether the usable free space is sufficient to store the variable; and
store the variable in the non-volatile store in response to a determination that the useable free space is sufficient.

30. The computing device of claim 29, wherein:
to determine the usable free space comprises to determine the usable free space based on a physical free space of the non-volatile store and a predicted compression ratio of the non-volatile store; and
to store the variable further comprises to:
compress the variable to produce compressed variable data;
store the compressed variable data in the non-volatile store; and
update the predicted compression ratio based on the compressed variable data.

31. The computing device of claim 26, wherein:
the call for services comprises a call to query information for a variable stored in the non-volatile store; and
to respond to the call for services comprises to return the usable free space to a caller of the call to query information.

32. The computing device of claim 31, wherein to determine the usable free space comprises to determine the usable free space based on a physical free space of the non-volatile store and a predicted compression ratio of the non-volatile store.

33. A method for providing services to a data store, the method comprising:
receiving, by a computing device, a call for services to a non-volatile store of the computing device;
determining, by the computing device, usable free space in the non-volatile store based on a non-volatile store policy, the non-volatile store policy defining a minimum amount of reserved space in the non-volatile store; and
responding, by the computing device, to the call for services based on the usable free space in the non-volatile store.

34. The method of claim 33, wherein determining the usable free space further comprises:
determining an identity of a caller of the call for services; and
determining the usable free space based on the non-volatile store policy and the identity of the caller, the non-volatile store policy defining an amount of reserved space based on the identity of the caller.

35. The method of claim 33, wherein:
receiving the call for services comprises receiving a call to set a variable in the non-volatile store; and
responding to the call for services comprises:
determining whether the usable free space is sufficient to store the variable; and
storing the variable in the non-volatile store in response to determining the useable free space is sufficient.

36. The method of claim 35, wherein:
determining the usable free space comprises determining the usable free space based on a physical free space of the non-volatile store and a predicted compression ratio of the non-volatile store; and
storing the variable further comprises:
compressing the variable to produce compressed variable data;
storing the compressed variable data in the non-volatile store; and
updating the predicted compression ratio based on the compressed variable data.

37. The method of claim 33, wherein:
receiving the call for services comprises receiving a call to query information for a variable stored in the non-volatile store; and
responding to the call for services comprises returning the usable free space to a caller of the call to query information.

38. The method of claim 37, wherein determining the usable free space comprises determining the usable free space based on a physical free space of the non-volatile store and a predicted compression ratio of the non-volatile store.

39. One or more computer-readable storage media comprising a plurality of instructions that in response to being executed cause a computing device to:
receive a call for services to a non-volatile store of the computing device;
determine usable free space in the non-volatile store based on a non-volatile store policy, the non-volatile store policy defining a minimum amount of reserved space in the non-volatile store; and
respond to the call for services based on the usable free space in the non-volatile store.

40. The one or more computer-readable storage media of claim 39, wherein to determine the usable free space further comprises to:
determine an identity of a caller of the call for services; and
determine the usable free space based on the non-volatile store policy and the identity of the caller, the non-volatile store policy defining an amount of reserved space based on the identity of the caller.

41. The one or more computer-readable storage media of claim 40, wherein to determine the identity of the caller comprises to analyze a return address stored in a system stack of the computing device.

42. The one or more computer-readable storage media of claim 39, wherein:
to receive the call for services comprises to receive a call to set a variable in the non-volatile store; and
to respond to the call for services comprises to:
determine whether the usable free space is sufficient to store the variable; and
store the variable in the non-volatile store in response to determining the useable free space is sufficient.

43. The one or more computer-readable storage media of claim 42, wherein:
to determine the usable free space comprises to determine the usable free space based on a physical free space of the non-volatile store and a predicted compression ratio of the non-volatile store; and
to store the variable further comprises to:
compress the variable to produce compressed variable data;
store the compressed variable data in the non-volatile store; and
update the predicted compression ratio based on the compressed variable data.

44. The one or more computer-readable storage media of claim 39, wherein:
to receive the call for services comprises to receive a call to query information for a variable stored in the non-volatile store; and
to respond to the call for services comprises to return the usable free space to a caller of the call to query information.

45. The one or more computer-readable storage media of claim 44, wherein to determine the usable free space comprises to determine the usable free space based on a physical free space of the non-volatile store and a predicted compression ratio of the non-volatile store.
